(19) United States
(12) Patent Application Publication
(10) Pub. No.: US 2026/0155848 A1
(43) Pub. Date: Jun. 4, 2026

(54) ELECTRONIC DEVICES, WIRELESS HIGH-BANDWIDTH IOT NETWORKING SYSTEMS, DEVICES, AND THEIR CONTROL METHODS AND STORAGE INSTALLATIONS

(71) Applicant: SMART CONSTRUCTION LABORATORY LIMITED, HONG KONG (CN)

(72) Inventors: HENG LI, HONG KONG (CN); DONGLIANG HAN, HONG KONG (CN)

(21) Appl. No.: 19/457,376

(22) Filed: Jan. 23, 2026

Related U.S. Application Data
(63) Continuation of application No. PCT/AU2024/050051, filed on Jan. 30, 2024.

(51) Int. Cl. H04B 1/00

(52) U.S. Cl. CPC H04B 1/0067

(57) ABSTRACT

This invention pertains to a cutting-edge wireless high-bandwidth Internet of Things (IoT) networking system and device. It encompasses Layer 1 (L1) and Layer 2 (L2) processing modules, with the L1 module overseeing the operational modes of the L2 modules, namely, Host or Client modes. When operating in Host mode, L2 delivers wireless access services, whereas in Client mode, it establishes wireless connections with other devices. This configuration facilitates direct, high-bandwidth wireless IoT communication among multiple devices. The ingenious design obviates the necessity for L2 modules to toggle between Host and Client modes, thereby elevating the efficiency and effectiveness of wireless networking. Furthermore, this innovation can be flexibly applied across various industrial contexts, including Smart Cities, Industrial Automation, Healthcare, Smart Homes and Agriculture.

### CROSS-REFERENCES TO RELATED APPLICATIONS

The present disclosure is a continuation application of International application No. PCT/AU 2024/050051, filed on Jan. 30, 2024, with the Australian Patent Office, the disclosures of which are incorporated herein by reference in their entireties.

### TECHNICAL FIELD

The present invention relates to the field of Wireless High-Bandwidth Internet of Things (IoT) Networking Devices and their associated control methodologies, and more particularly, it pertains to wireless communication technology and network technology. The field of “Wireless High-Bandwidth Internet of Things (IoT) Networking Devices and Their Associated Control Methodologies” refers to a domain that focuses on the development and research of wireless communication and networking technologies, particularly within the context of the Internet of Things (IoT). In this field, the primary objective is to create IoT devices capable of supporting high-bandwidth requirements, enabling wireless communication and data exchange among various smart devices and sensors. From its definition, The realm of wireless communication technology is a dynamic and rapidly evolving field, integral to the modern digital landscape. It encompasses a wide range of technologies, standards, and applications that facilitate the transmission of data over the air, eliminating the need for physical connections like wires or cables. And then The field of network technology, a pivotal aspect of the information technology (IT) landscape, encompasses a wide range of concepts, tools, and methodologies involved in the transmission, management, and security of data across various types of networks. At the core of network technology lies the physical infrastructure, including routers, switches, and hubs, which form the backbone of any network setup. These devices facilitate the flow of data across networks, ensuring that information is routed and managed efficiently. The transmission media such as twisted-pair cables, fiber optics, and wireless signals serve as the conduits for data, varying in speed, capacity, and suitability for different environments and applications.

In summary, the present patent pertains to the realm of wireless communication and networking technologies, with a specific focus on the advancement and deployment of wireless, high-bandwidth IoT networking devices and their associated control methodologies. This innovation introduces a novel approach to wireless networking, placing significant emphasis on harnessing L1 and L2 processing modules for the management and optimization of electronic device operations. This, in turn, facilitates seamless connectivity and efficient communication within the IoT networks.

The primary objective of this invention is to elevate the performance and reliability of wireless IoT networks by offering inventive solutions for overseeing the operational modes of L2 processing modules, the meticulous allocation of frequency resources, and the assurance of redundancy and resilience in IoT device connections. Furthermore, this patent extends its purview to encompass electronic devices endowed with wireless, high-bandwidth IoT capabilities. It underscores the integration of control circuitry with IoT devices to amplify their functionality. This patent addresses the forefront of developments in wireless IoT networking systems, presenting heightened network efficiency, efficacy, and connectivity for a wide spectrum of electronic devices and equipment.

### BACKGROUND ART

In the field of wireless communication technology and network technology, there has been a continuous quest for advancements and innovations to address various challenges and limitations. The following discussion provides an overview of the background art relevant to the present invention, highlighting existing technologies, methods, and drawbacks.

The field of wireless communication technology and network technology has seen significant advancements in recent years. However, certain challenges and limitations persist, such as, 1) Limited Bandwidth: Wireless communication technologies often have limited bandwidth, which can restrict data transfer speeds and capacity. In high-demand scenarios, bandwidth limitations can lead to network congestion and reduced performance. 2) Signal Interference: Wireless communication is susceptible to external signal interference, such as electromagnetic interference and physical obstructions. This interference can degrade signal quality and impact communication reliability. 3) Security Concerns: Wireless technologies are vulnerable to security threats, including unauthorized access, data breaches, and network intrusions. Ensuring the security of wireless networks is an ongoing challenge. 4) Limited Coverage Range: Wireless communication technologies typically have a limited coverage range, especially for technologies like Wi-Fi and cellular networks. Devices must be in proximity to signal sources, or else connections may become unstable or drop altogether. 5) Infrastructure Requirements: Wireless communication technologies require corresponding infrastructure such as base stations, routers, and signal towers. Deploying and maintaining this infrastructure can be challenging in certain regions or remote areas. 6) Power Consumption: Some wireless devices have high power consumption, especially when using high bandwidth or high-power transmission. This can result in shorter battery life and the need for frequent recharging or battery replacement. 7) Privacy Issues: Wireless communication technologies and network technologies may raise privacy concerns, including location tracking, data monitoring, and information leakage. Adequate privacy protection measures are necessary to address these issues.

Currently, the most popular technology in wireless mesh networks (MESH) requires an intermediary device when the wireless signal needs to travel a long distance from one device to another. For instance, if a signal needs to be transmitted from Device 1 to Device 3, Device 2 acts as a relay device due to the distance. At present, Device 2 performs two roles: 1) receiving the signal from Device 1, and 2) transmitting the signal to Device 3. Consequently, Device 2 must constantly switch between receiving and transmitting states according to a time sequence. In one time period, Device 2 is in the receiving state for Device 1, and in the next, it is in the transmitting state for Device 3. This current relay mode has several drawbacks, such as:
Due to the timing of the switching operation mode of Relay 2, the response speed is reduced, resulting in the transmission rate being halved. The more frequently the relays are used, the greater the impact on the transmission rate.
In long-distance networking, different frequency bands experience varying levels of interference. This increases the likelihood of interference, further reducing the transmission rate.

This mode of communication is also referred to as point-to-point communication, or AP (Access Point) +multi-point STA (Station) mode. In this mode, all STA devices are connected to APs to form a communication network. Each point in this network has the same device identity, the support distance is limited, and it lacks the capability to network more than two Aps.

These limitations have created a demand for innovative solutions that can address: 1) Heightened Bandwidth Demand: There is an escalating need for expanded bandwidth capacity to facilitate swift data transmission and the seamless delivery of premium multimedia content. 2) Fortified Security Infrastructure: In light of the burgeoning landscape of cyber threats and data breaches, an imperative exists for robust network security measures to fortify the protection of user data and privacy. 3) Wider Geographical Reach: To accommodate the burgeoning connectivity requisites, it becomes imperative to extend the geographical footprint of network coverage, encompassing the provisioning of steadfast connectivity in rural and remote hinterlands. 4) Energy-Efficient Solutions: To protract the operational lifespan of portable devices, the advancement of energy-efficient communication technologies is imperative to curtail energy consumption. 5) Enhanced Device Interoperability: Realizing seamless interoperability amid a myriad of devices and networks necessitates the establishment of more cohesive standards and protocols. 6) Augmented Network Reliability: Particularly in mission-critical domains such as healthcare and industrial automation, heightened network reliability is indispensable to ensure uninterrupted operations and uninterrupted data transmission. 7) Cognizant Network Management: With the proliferation of IoT devices, adept network administration and adaptability are requisite to proficiently manage network traffic and resources.

### SUMMARY OF INVENTION

The invention provides electronic devices, wireless high bandwidth IoT networking systems, devices, and its control methods and storage installations. The wireless AI high bandwidth IoT networking device invention includes an L1 layer processing module and/or a plurality of L2 layer processing modules. The L2 layer processing module has a Host working mode and a Client working mode. Host mode is used to support wireless access service for the client or other wireless terminal devices, while the Client mode is used to wirelessly connect to other L2 layer processing modules or wireless devices operating in Host mode. The L1 layer processing module controls at least one L2 layer processing module to work in the host mode or controls other sub-processing modules to work in the client mode. The invention employs a multiplicity of logical processing modules, with the L1 layer processing module controlling the L2 layer processing modules to work in Host or Client mode, and ensuring at least one Host mode L2 layer processing module in a device. This design realizes wireless high-bandwidth direct IoT between multiple devices, while the L2 layer processing modules no longer need to switch back and forth between Host and Client modes, thus achieving a great breakthrough in wireless networking capability and improving the networking efficiency and effectiveness of the wireless network.

A storage device is defined as follows: 1) To accomplish the steps of the control method for the wireless high-bandwidth IoT device described in any of the above items, the storage device stores one or more programs that can be executed by one or more processing modules. 2) The storage device stores one or more programs to build a novel and efficient networking of electronic devices.

### TECHNICAL PROBLEM

The technical problem addressed by this invention can be summarized as follows:

1) Elevating Wireless Network Bandwidth: The challenge lies in devising a strategy to attain high-bandwidth, direct IoT communication amidst multiple devices, catering to the demands of intricate and data-intensive applications.

2) Augmenting Network Efficiency and Efficacy: There exists a pressing demand for a methodology that can refine the performance of wireless networks, thereby amplifying their processing prowess and responsiveness.

3) Mitigating Mode Transition: Within the current technological landscape, the frequent oscillation of L2 layer processing modules between Host and Client modes poses a predicament, characterized by inefficiencies and latency.

In summary, how to enhance wireless networking systems for high-bandwidth IoT (Internet of Things) communication while improving the efficiency and effectiveness of the wireless network. This involves the need to establish wireless connections between electronic devices and IoT networking modules efficiently, without the constant switching of L2 layer processing modules between Host and Client modes. Meanwhile, it is also necessary to consider the following aspects. for example, Security and Privacy: In IoT networks, ensuring data security and user privacy is a critical technical challenge that the system must address. Hence, a solution is imperative to curtail the necessity for such mode transitions.

### SOLUTION TO PROBLEM

A wireless high-bandwidth Internet of Things (IoT) intelligent networking device:

A Layer 2 processing module operates in Host mode and/or Client mode. Its Host mode provides wireless access services to connect with other wireless devices, while its Client mode connects to other Layer 2 processing modules operating in Host mode or relevant wireless devices. The Layer 1 processing module controls one or more Layer 2 processing modules to operate in Host mode and/or controls other Layer 2 processing modules to operate in Client mode. The working mode of the Layer 2 processing module is defined by the Layer 1 processing module as needed, and the networking is achieved by controlling the working mode of each Layer 2 processing module through the Layer 1 processing module.

In the context of wireless high-bandwidth IoT devices for wireless artificial intelligence networking, the Layer 1 processing module controls some Layer 2 processing modules to operate in Client mode and others in Host mode according to network requirements. The Layer 1 processing module integrates hardware device underlying drivers, embedded operating systems, and artificial intelligence algorithm networking control systems. Through an Layer 1 processing module, each Layer 2 processing module is controlled to operate at different frequencies and/or modes, constructing a backhaul wireless link to form a convergence layer and an independent access layer.

The uniqueness of this invention includes the following four aspects.

1) At least one Layer 1 processing module and several (one or more) Layer 2 processing modules, each of which is wired to the Layer 1 processing module. The Layer 1 processing module and Layer 2 module are set on the same PCB board or on different PCBs, and the Layer 1 processing module and Layer 2 module are set in different chips or integrated in the same chip.

2) The above-mentioned 1) forms a new type of wireless networking system for devices and equipment. The Layer 1 processing module is also used to manage and allocate the working frequencies of each Layer 2 processing module, ensuring that each Layer 2 processing module operates on at least two working frequencies. There are two or more Layer 1 processing modules, creating a redundant pool capacity for Layer 1 processing modules online. Each Layer 1 processing module has a different working priority. When the Layer 1 processing module with the highest priority malfunctions, the next priority Layer 1 processing module takes over the responsibilities of the malfunctioning Layer 1 processing module.

3) The new wireless networking system for devices and equipment comprises at least two wireless devices. The wireless devices include at least one of the wireless high-bandwidth IoT devices described in 1) and/or 2). At least one Layer 2 processing module of the wireless high-bandwidth IoT device operates in Host mode, providing wireless access for other wireless devices. Alternatively, at least one Layer 2 processing module of the wireless high-bandwidth IoT device operates in Client mode, connecting to other wireless devices to establish a wireless high-bandwidth IoT network. When the wireless high-bandwidth IoT device is in operation, the Layer 1 processing module, based on networking requirements, controls a Layer 2 processing module to operate in Client mode and controls other Layer 2 processing modules to operate in Host mode. The integrated hardware device drivers, embedded operating system, and intelligent networking control system are incorporated into the Layer 1 processing module. Through a single Layer 1 processing module, various Layer 2 processing modules are controlled to operate at different frequencies and/or modes, simultaneously constructing a feedback wireless link to form a convergence layer and an independent access layer.

4) The invention is used for electronic devices with wireless high-bandwidth IoT functions, including control circuits, characterized by also including wireless high-bandwidth IoT devices as described in 1) and/or 2) one or two of the above; The wireless high-bandwidth IoT device is electrically connected to the control circuit. An electronic device with the wireless high-bandwidth IoT function of the present invention, characterized by the electronic device further including a control motherboard, and its control circuit and wireless high-bandwidth IoT device are both set on the control motherboard. The electronic device further comprises a control motherboard, wherein the control circuit is set on the control motherboard, and the wireless high-bandwidth IoT device is connected to the control motherboard through a wired interface.

The control method for a wireless high-bandwidth Internet of Things (IoT) device, as described in any of the above-mentioned items, is characterized by the following steps:

1) The L 1 layer processing module causes at least one L2 layer processing module to operate in Host mode, allowing other wireless devices to connect.

2) The L 1 layer processing module causes other L2 layer processing modules to operate in Client mode, connecting with other wireless devices.

3) The working mode of the L2 layer processing modules is established as needed by the L1 layer processing module. To build a network, the L1 layer processing module controls how each L2 layer processing module operates. Depending on the networking requirements, the L1 layer processing module commands one L2 layer processing module to operate in Client mode and other L2 layer processing modules to operate in Host mode while the wireless high-bandwidth loT device is in operation. The L1 layer processing module integrates hardware device drivers, embedded operating systems, and intelligent networking control systems. It manages the operation of several L2 layer processing modules at various frequencies and/or modes while simultaneously constructing a feedback wireless link to produce a convergence layer and an independent access layer.

Additional steps in the control method for the wireless high-bandwidth IoT device are as follows: The L1 layer processing module manages and allocates the working frequencies of each L2 layer processing module and ensures that each L2 layer processing module works on at least two frequencies. The L1 layer processing module with the highest priority manages the working status of each L2 layer and other L1 layer processing modules. The following procedures are part of the control method once the L2 layer processing modules are configured to function in Client mode to build wireless connections with other wireless devices:

1) When an L 2 layer processing module is in Client mode, it obtains the MAC address of the L2 layer processing module that is in Host mode on its own device.

2) After a wireless device is detected by the L2 layer processing module in Client mode, the L1 layer processing module identifies if the device's MAC address matches those already listed in its MAC address table.

3) The wireless device connection will not be built if the specified MAC address is already listed in the MAC address database.

4) The L 2 layer processing module operating in Client mode searches for other wireless devices and establishes wireless connections with them. After the L2 layer processing modules are configured to operate in Client mode and establish wireless connections with other wireless devices, the wireless high-bandwidth IoT device's control method involves the following steps:

5) When in Client mode, the L2 layer processing module searches for wireless devices that are available for wireless connections and creates a list of those devices.

6) The L 1 layer processing module connects wirelessly to the L2 layer processing module in Client mode by choosing the wireless device with the best connection quality from the list of available wireless devices.

7) The L 2 layer processing module operating in Client mode sends broadcast packets. The L2 layer processing modules receive broadcast packets sent by other wireless devices and the L1 layer processing module determines whether they are local broadcast packets.

8) If the broadcast packet is local, the relevant L2 layer processing module disconnects from the other wireless device and searches for additional wireless devices to establish a connection with. When in client mode, the L2 layer processing module transmits channel data to the L1 layer processing module for storage.

9) Operating in Host mode, the L2 layer processing module gathers channel information from nearby wireless devices, and the L1 layer processing module determines whether the obtained channel information is the same as the stored channel information. The L1 layer processing module instructs the Host mode L2 layer processing module to choose the channel with the best connection quality from the available channel list when the Host mode L2 layer processing module acquires channel information that matches the stored information.

10) When the Host mode L2 layer processing module receives broadcast packets sent by the Client mode L2 layer processing module, the L1 layer processing module identifies the current connection mode of the Client mode L2 layer processing module based on the broadcast packet.

11) The L 1 layer processing module instructs the Client mode L2 layer processing module to shut its wireless interface if it detects that the Client mode L2 layer processing module is linked to other wireless high-bandwidth IoT devices via a wired connection.

12) The Host mode L2 layer processing module continuously detects whether it can receive broadcast packets from other Client mode L2 layer processing modules of other wireless high-bandwidth IoT devices.

13) If the Host mode L2 layer processing module cannot receive broadcast packets from the Client mode L2 layer processing modules of other wireless high-bandwidth IoT devices, the main control module instructs the Client mode L2 layer processing module to disconnect the wired interface and enable the wireless interface.

### ADVANTAGEOUS EFFECTS OF INVENTION

From a technical perspective, the following issues have been resolved. 1) Mode Flexibility and Control: It innovates with a dual-mode (Host and Client) functionality in the L1 processing module, allowing dynamic switching and control to optimize network traffic. 2) Efficient Bandwidth Management: By intelligently managing bandwidth, the system ensures high-speed data transfer and connectivity in dense IoT environments. 3) Redundant Processing Capabilities: Multiple L1 modules ensure network reliability through redundancy. 4) Integration of Hardware and Software: The system integrates hardware drivers, operating systems, and AI algorithms for optimal network control.

### BRIEF DESCRIPTION OF DRAWINGS

The embodiments herein may be better understood by referring to the following description in conjunction with the accompanying drawings in which like reference numerals indicate identically or functionally similar elements, of which:

FIG. 1 illustrates a schematic diagram of the IoT networking device processing modules according to the invention;

FIG. 2 illustrates a structural diagram of the wireless intelligent networking device;

FIG. 3 illustrates a structural diagram for wireless intelligent networking;

FIG. 4 illustrates a schematic diagram of the first networking method; and

FIG. 5 illustrates a schematic diagram of the second networking method.

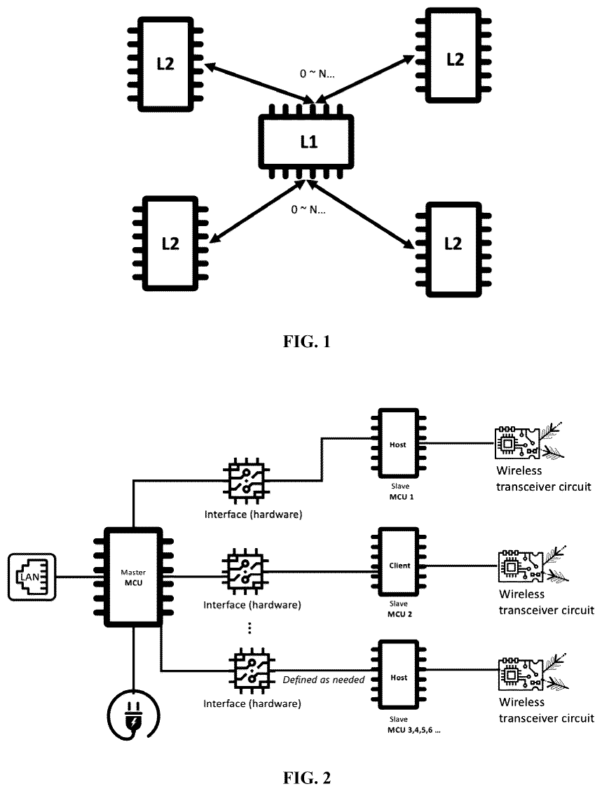

### IMPLEMENTATION DETAILS

The wireless intelligent networking device of the present invention comprises a L1 layer processing module (main) and a plurality of L2 layer processing modules (slave), and each L2 layer processing module (slave) is wired with the L1 layer processing module (main).

The L2 layer processing module (slave) has an access point operating mode and/or a terminal working mode; wherein the access point working mode is used for providing wireless access services for other wireless devices to be connected, the terminal working mode is used for connecting other L2 layer processing module (slave) or wireless devices operating in access point mode; the L1 layer processing module (main) is used for controlling at least one L2 layer processing module (slave) working in access point mode, and/Or control other L2 layer processing module (slave) to work in terminal mode, and control the data transmission mode of each slave processing module.

When the wireless intelligent networking device is in wireless networking, each L2 layer processing module (slave) is in a certain working mode, and the L1 layer processing module (main) is specifically controlled to work in a certain working mode according to the networking requirements. Specifically, the L2 layer processing module (slave) working in access point mode can be connected by a plurality of L2 layer processing module (slave) or other wireless devices of other wireless intelligent networking devices, and the L2 layer processing module (slave) working in terminal mode can only connect one L2 layer processing module (slave) or other types of wireless devices working in access point mode.

As shown in FIG. 2, the L1 layer processing module and the L2 layer processing module are arranged on the same PCB board, and the L1 layer processing module (main) and each L2 layer processing module (slave) are connected through PCB wiring, so that the wireless intelligent networking device can be made into the form of a module, and directly docked with other electronic equipment. Of course, the L1 layer processing module (main) and the L2 layer processing module (slave) are arranged on different PCB boards, that is, the L1 layer processing module (main) and each L2 layer processing module (slave) can be arranged on different PCB boards, the L1 layer processing module (main) and each L2 layer processing module (slave) are connected by wire, and they are installed separately, and when it is docked with other electronic equipment, the installation position of the L1 layer processing module (main) and each L2 layer processing module (slave) can be selected according to the structure of the electronic equipment, so that the wireless intelligent networking function of the electronic equipment is realized.

Specific examples: MCU1 (A) is a L2 layer processing module (slave) working in access point mode, MCU2 (S) is a L2 layer processing module (slave) working in terminal mode, MCU3/4/5/6 . . . (defined as required) needs to be represented, MCU3, MCU4, MCU5, etc. The operating mode is defined by the Master MCU (L1 layer processing module) as needed. The wireless intelligent networking device controls the working mode of each L2 layer processing module through the L1 layer processing module (main) and carries out networking, and the wireless LAN that is formed provides wireless LAN services, such as WIFI network. The L1 layer processing module (main) is also used for managing and allocating the working frequencies of each L2 layer processing module (slave), and makes each L2 layer processing module (slave) work at least two working frequencies, so that the co-channel interference problem during multi-level data transmission is effectively avoided.

This device can be applied to all wireless devices, including wireless smart networking devices, routers, smartphones, video cameras, computers, home appliances, etc. As shown in FIG. 3, there is a wired connection between wireless devices, or a wireless connection. When wired connection, wireless devices can be directly connected by network port or serial port, when wireless connection, directly connected by wireless mode, each wireless device can use different frequencies for data interaction, so as to avoid co-channel interference, and the network bandwidth is wider, and the networking is more flexible.

If the wireless intelligent networking device is installed on the motherboard of the smart home appliance and the wireless intelligent networking device is directly arranged, the wireless intelligent networking device can be directly mounted on the home appliance motherboard in the form of a chip, and the space it occupies is small, the wireless Internet access and networking function of the smart home appliance are realized, and the data can be interacted with other electronic devices through wireless mode, the cumbersome wired wiring is avoided, and the smart home control in the real sense is realized.

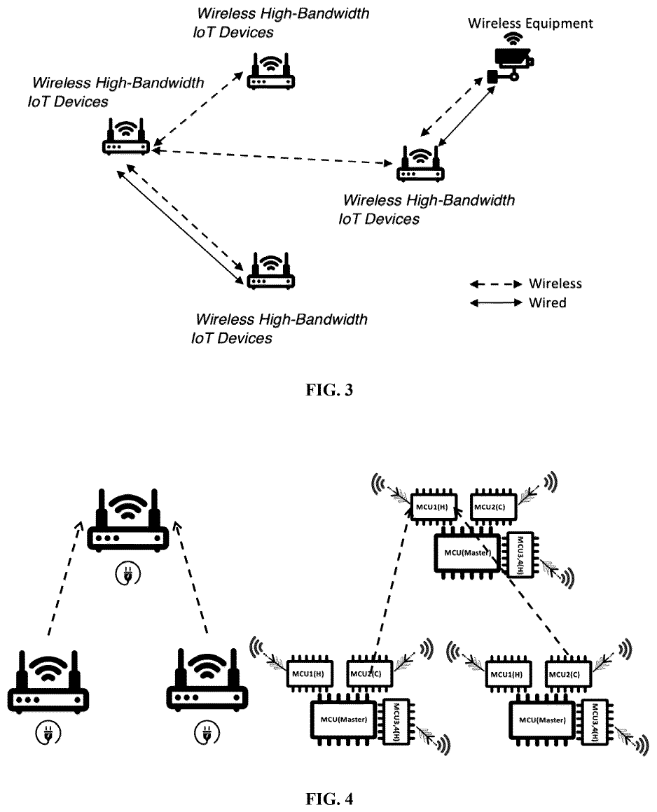

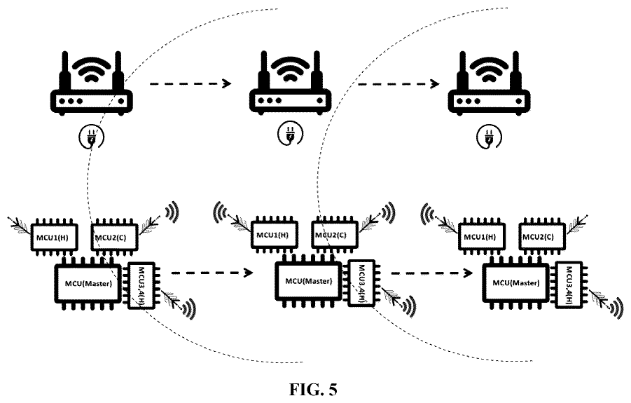

FIG. 4 shows an example: the L1 layer processing module is the Master MCU, MCU1 and MCU3 are the L2 layer processing module working in access point mode, and MCU2 is working in terminal mode The Master MCU controls MCU1 and MCU3 to work in access point mode, and controls MCU2 to work in terminal mode, realizes wireless intelligent networking, and each L2 layer processing module (slave) does not need to switch back and forth in access point mode and terminal mode, that is, the present invention separates link layer and access layer, will greatly improve response speed, and system is more stable. And the present invention controls a plurality of L2 layer processing module (slave) to work in different modes by the L1 layer processing module (main), reduces the rate loss of multi-level data transmission, and effectively solves the problem of WIFI bandwidth attenuation of existing relay mode.

The Master MCU of the local device orchestrates MCU2 of the local machine to initiate a search for available MCU1 units within the vicinity of the wireless intelligent networking device, compiling a list of potential wireless connections. Subsequently, the Master MCU of the local machine employs a networking algorithm stored within the device to meticulously select the L2 layer processing module offering the most optimal connectivity quality. It then instructs the local MCU2 to establish a wireless connection with this chosen module.

Following the connection attempt, the primary MCU of the local device assesses the success of the wireless connection. In the event of an unsuccessful connection, the local MCU's Master MCU takes charge and directs MCU2 to identify an external MCU1 with the second-strongest signal strength. It then guides MCU2 in establishing a wireless connection with this alternative MCU1 unit.

### Description of Embodiments

Wireless IoT devices with high bandwidth capabilities, along with their control methodologies, can be applied across a myriad of practical scenarios with the primary objective of augmenting communication, data transmission, and interoperability among IoT devices. Here are several prospective instances of real-world application scenarios: intelligent residences, industrial automation, agricultural operations, smart urban environments, healthcare systems, intricate transportation logistics, meticulous energy management, and sophisticated retail solutions. (FIG. 2) From a technical standpoint, it includes the following content specifically: 1) L 1 and L 2 Layer Processing Modules: The system comprises at least one L1 layer processing module and several L2 layer processing modules. The L1 layer controls the working modes of the L2 layers, which can operate in either Host or Client mode. This allows for flexible networking and communication between devices. 2) Working Modes and Networking: The L1 layer module can set the L2 layer modules in Host mode for wireless access service or in Client mode for connecting to other devices. This design facilitates a high-bandwidth IoT network, improving networking efficiency. 3) Control Method: The control method involves configuring the L1 and L2 layer modules to operate in specific modes based on networking needs. This includes managing frequencies, determining connection modes, and establishing wireless connections. 4) Storage Device: The system also includes a storage device for storing programs that execute these control methods, aiding in efficient networking of electronic devices. To implement this in a practical scenario, one would need to configure the L1 and L2 modules according to specific networking requirements, ensure proper frequency allocation, and manage connections between devices for optimal networking performance.

### EXAMPLES

Introduction: Based on the above content, it can be determined that this invention pertains to a technology involving wireless high-bandwidth Internet of Things (IoT) devices and their control methods.

Scenario Description: Construction Site

Operational Process: The patent for the innovative wireless high-bandwidth IoT networking system has multiple specific applications on a construction site, offering numerous potential advantages such as real-time equipment monitoring and control, increased work efficiency, and enhanced worker safety. Here are detailed operational processes for its implementation on a construction site:

Equipment Monitoring and Maintenance:

1) Various construction site equipment, including excavators, cranes, and concrete mixers, can be equipped with IoT sensors capable of monitoring equipment status, fuel consumption, temperature, and other data. 2) Utilizing the high-bandwidth communication method outlined in the patent, this data can be transmitted in real-time to either a central control center or the devices used by the construction site management team. This allows them to continually monitor equipment performance. 3) In cases of equipment malfunction or the necessity for maintenance, the system can autonomously send alerts, facilitating prompt action by maintenance teams to minimize downtime.

Construction Site Surveillance:

Cameras and sensors can be strategically positioned throughout the construction site to monitor various activities. 2) By utilizing high-bandwidth connections, personnel responsible for monitoring can remotely access real-time camera feeds. This ensures seamless progress and enables immediate action to address any emerging issues.

Safety Oversight:

Workers can be equipped with smart safety gear, such as helmets or vests, embedded with IoT sensors. 2) These sensors have the capability to monitor aspects such as worker positions, body temperature, heart rate, and other health and safety indicators.3) In instances where potential safety risks are identified, the system can promptly dispatch alerts for emergency response measures.

Material Management:

1)Materials and construction supplies can be tagged with RFID labels or other tracking technologies. 2)These tags can be scanned and recorded within the system to monitor the movement and inventory levels of materials. 3)This efficient management of material supply aids in reducing waste and delays.

Real-time Data Analysis:

The system is capable of gathering and analyzing extensive data from the construction site, encompassing equipment performance, worker activities, and material inventory. This data can be leveraged to optimize construction schedules, allocate resources efficiently, and predict potential issues.

These examples of operational processes elucidate the practical application of the novel wireless high-bandwidth IoT networking system within a construction site. The invention holds the potential to elevate construction site management, safety protocols, efficiency, and resource utilization.

Results and Benefits: This design realizes wireless high-bandwidth direct IoT between multiple devices, while the L2 layer processing modules no longer need to switch back and forth between Host and Client modes, thus achieving a great breakthrough in wireless networking capability and improving the networking efficiency and effectiveness of the wireless network.

In summary, the patent for the innovative wireless high-bandwidth Internet of Things (IoT) networking system holds vast potential for applications, especially in the realm of construction site management. It can facilitate real-time equipment monitoring and control, elevate work efficiency, enhance worker safety, streamline material supply management, and enable real-time data analysis, among numerous other functionalities. This patent introduces a groundbreaking solution for construction sites, offering the prospect of substantial advantages and advancements within the construction and building sector.

Moreover, its applicability extends to various other industries.

### INDUSTRIAL APPLICABILITY

A “Wireless High Bandwidth IoT Networking System and Device” is designed to significantly enhance the capabilities of Internet of Things (IoT) networks.

This patent has diverse applications, such as: 1) Smart Cities: Enhancing urban infrastructure, traffic control, and public safety through interconnected IoT devices. 2) Industrial Automation: Facilitating real-time monitoring and control in manufacturing and processing industries. 3) Healthcare: Improving patient care with real-time monitoring and telemedicine capabilities. 4) Smart Homes: Enabling advanced home automation and energy management systems. 5) Agriculture: Assisting in precision farming through data collection and analysis for crop management.

In detail, as follows:

1) Application Industry: Smart Cities and Urban Infrastructure

2) Main Application Scenarios: Traffic Management: Utilizing IoT devices for monitoring and managing city traffic, reducing congestion, and improving road safety. Public Safety: Implementing IoT devices in surveillance systems to enhance public security and emergency response capabilities. Utilities Management: Optimizing energy distribution, water management, and waste disposal through IoT-enabled monitoring and control systems.

How to Apply:

Traffic Management: Deploy IoT sensors at key traffic junctions and roads. Use the technology to collect real-time traffic data and control traffic lights and signs dynamically. Integrate with city-wide traffic management systems for efficient flow control.

Public Safety: Install IoT devices in public areas for real-time surveillance and incident detection. Enable swift response to emergencies by integrating IoT devices with local law enforcement and emergency services.

Utilities Management: Implement IoT sensors in electricity, water, and waste management systems. Monitor usage patterns, detect leaks or faults, and optimize distribution. Provide data-driven insights for sustainable urban planning.

Specific Content: Use the Layer 1 and Layer 2 processing modules for efficient networking between IoT devices. Configure devices in Host and Client modes as required for specific applications (e.g., traffic sensors in Host mode, surveillance cameras in Client mode). Employ the control method outlined in the patent for managing networking, frequency allocation, and device connections. Leverage the storage installations for program execution, ensuring seamless operation of the IoT network.

1. A Wireless High-Bandwidth IoT Networking Device including
1) at least one Layer 1 (L1) processing module and two or more Layer 2 (L2) processing modules;
2) the L1 processing module functions in two modes: Host and Client, the Host mode supports wireless access for clients or wireless terminal devices, while the Client mode connects wirelessly to at least one L2 processing module or wireless device operating in Host mode;
3) the device controls at least one L2 processing module in Host mode, and sub-processing modules in Client mode;
4) at least one Host mode L2 processing module in the device facilitating direct IoT (Internet of Things) communication between multiple devices without the need for L2 processing modules to switch between Host and Client modes.

2. The Wireless High-Bandwidth IoT Networking Device as claimed in claim 1, wherein at least one of the two or more Layer 2 Processing Modules is in either Host or Client mode where in Host mode, said at least one of the two or more L2 Processing Modules provide wireless access services to connect with other wireless devices and in Client mode said at least one of the two or more L2 Processing Modules connect to other L2 processing modules operating in Host mode or relevant wireless devices; the working mode of the at least one of the two or more L2 processing module is defined and controlled by the L1 processing module as per networking requirements.

3. The Wireless High-Bandwidth IoT Networking Device as claimed in claim 1, wherein the L1 processing module integrates hardware device drivers, embedded operating systems, and artificial intelligence algorithm networking control systems; such that the L1 processing module controls the operation of the at least two L2 processing moducles at different frequencies and modes, constructing a backhaul wireless link to form a convergence layer and an independent access layer.

4. The Wireless High-Bandwidth IoT Networking Device as claimed in claim 1, wherein the L1 processing module and the two or more L2 modules are set on the same PCB board or different PCBs, and in different chips or integrated into the same chip; such that the L1 processing module manages and allocates working frequencies for each of the two or more L2 processing modules, ensuring operation on at least two frequencies.

5. The Wireless High-Bandwidth IoT Networking Device as claimed in claim 1, wherein multiple L1 processing modules create a redundant pool, each L1 processing module with different working priority; where a malfunction in a high-priority L1 module, causes the next priority module to take over.

6. A Control Method for the Wireless High-Bandwidth IoT Device as claimed in claim 1, said control method includes using the L1 layer processing module to direct at least one of the two or more L2 layer processing modules to Host or Client mode based on networking requirements;
1) setting the two or more L2 processing modules to operate at various frequencies and modes to construct a feedback wireless link and managing and allocating working frequencies, identifying MAC addresses, establishing and disconnecting wireless connections, and choosing channels based on quality indicia.
